(19) United States
(12) Patent Application Publication
(10) Pub. No.: US 2003/0073773 A1
(43) Pub. Date: Apr. 17, 2003

(54) Impact-modified polymer compositions

(76) Inventors: Marc Vathauer, Koln (DE); Gerwolf Quaas, Koln (DE); Dieter Wittmann, Leverkusen (DE)

Correspondence Address: BAYER CORPORATION, PATENT DEPARTMENT, 100 BAYER ROAD, PITTSBURGH, PA, 15205, US

(21) Appl. No.: 10/260,789

(22) Filed: Sep. 30, 2002

(30) Foreign Application Priority Data
Oct. 4, 2001 (DE) 10149152.2

(51) Int. Cl. C08K 3/34

(52) U.S. Cl. 524/447; 524/514; 524/451; 524/449; 524/493

(57) ABSTRACT

The invention relates to impact-modified polyamide compositions and moldings produced therefrom which are suitable for on-line lacquering, and the production of moldings which have been subjected to on-line lacquering.

### FIELD OF THE INVENTION

The invention relates to impact-modified polyamide compositions and moldings produced therefrom suitable for on-line lacquering.

### BACKGROUND OF THE INVENTION

DE-A 101 019 225 describes polymer compositions comprising a polyamide, a graft polymer, a vinyl (co)polymer, a compatibilizer and very finely divided mineral particles having anisotropic particle geometry. However, DE-A 101 019 225 does not disclose that the polymer compositions can be subjected to on-line lacquering.

EP 0 202 214 A discloses polymer blends of a polyamide, a styrene/acrylonitrile copolymer and a compatibilizer. The composition employs as the compatibilizer a copolymer of a vinylaromatic monomer and acrylonitrile, methacrylonitrile, C₁ to C₄-alkyl methacrylate or C₁ to C₄-alkyl acrylate in a weight ratio of 85:15 to 15:85. An increased impact strength is said to be achieved by the use of these compatibilizers. A disadvantage of the polymer blends described therein is that they have a rigidity, which is too low, and an expansion coefficient, which is too high for thin wall applications.

JP 11 241 016 A2 discloses polyamide molding compositions which comprise, in addition to polyamide, rubber-modified styrene polymers, graft polymers based on ethylene/propylene rubbers and talc with a particle diameter of 1 to 4 μm.

EP-A 0 718 350 discloses polymer blends of a crystalline and an amorphous or a semi-crystalline polymer containing 2-7 wt. % of an electrically conductive hydrocarbon (carbon black) which are suitable for the production of moldings. The moldings produced therefrom may be subjected to electrostatically lacquering.

The use of finely divided inorganic materials in certain polymer compositions, in particular in polycarbonate compositions, is furthermore generally known. The inorganic materials are employed in these compositions, for example, as a reinforcing substance to increase the rigidity and tensile strength, to increase the dimensional stability during variations in temperature, to improve the surface properties or—in flame-resistant materials—also as a flameproofing synergist. Both mineral and synthetically obtained materials are used. Thus, U.S. Pat. No. 5,714,537 describes, for example, polycarbonate blends, which comprise particular inorganic fillers to improve the rigidity and resistance to linear thermal expansion.

DE-A 39 38 421 A1 describes molding compositions of polyamides and specific graft polymers comprising tert-alkyl esters. These polymers have a high gloss on the surface and good dimensional stability. However, a further improvement in the impact strength, such as is necessary for thin wall applications, would be desirable.

EP 0 785 234 A1 discloses rubber-modified polymer composition which comprise a terpolymer of styrene, acrylonitrile and maleic anhydride as a compatibilizer. The addition of the compatibilizer leads to an improvement in the mechanical properties, in particular the impact strength at low temperatures. However, it is a disadvantage that the overall profile of properties of the polymer, in particular the processing properties during injection molding, suffers with the addition of the compatibilizer.

WO 01/34703 discloses impact-modified polyethylene terephthalate/polycarbonate blends which are suitable for on-line lacquering. Polyamide blends are not described.

Noryl® GTX from General Electric Plastics is known for some in-line uses. This is a blend comprising a polyamide and a polyphenylene ether (PA/PPO blend).

External vehicle body components of plastics should, as a rule, be lacquered. In the case of plastics which are colored, the color of the coach, the components produced therefrom, which are built on to the vehicle body are as a rule coated with one or more layers of transparent lacquers. In the case of plastics which are not colored the color of the coach, the components produced therefrom, which are built on to the vehicle body are lacquered with several layers of lacquer, at least one of the layers imparting color (top lacquer). Depending on the heat distortion temperature of the plastics, a distinction is made here between different processes that differ in the time at which the components of plastic built-on are attached to the external vehicle body component. If the components of plastic built-on also pass through the entire lacquering process, “on-line” lacquering is generally referred to, this imposes the greatest requirement on the heat distortion temperature of the plastic. In the case of so-called “in-line” lacquering, the component of plastic built-on is assembled on to the external vehicle body component after so-called cathodic dip coating (CDC) and introduced into the lacquering line. In the case of so-called “off-line” lacquering, the entire component of plastic built-on is lacquered outside the lacquering line at low temperatures and only then assembled on to the external vehicle body component.

The “on-line” process is preferred by the car industry since it minimizes the working steps and moreover the best color match of plastic and sheet metal is achieved. Temperatures of up to 205° C. are achieved in this process, therefore high requirements are imposed on the heat distortion temperature of the molding.

Additional requirements imposed on components of plastic built-on to the vehicle body are good rigidity, low thermal expansion and after-shrinkage, good surface quality, good lacquerability, adequate toughness and good resistance to chemicals. Furthermore, the molding compositions used to produce the external vehicle body components must have good flow properties in the melt.

### SUMMARY OF THE INVENTION

The object of the present invention was to provide polyamide molding compositions, which have an excellent heat distortion temperature and low thermal expansion. The compositions according to the present invention additionally have an increased tensile strength with simultaneously good processing properties.

The present invention is directed to a polymer composition containing:

(A) 55-90 parts by wt. of a polyamide,

(B) 0.5-50 parts by wt. of a graft polymer

(C) 0.1-30 parts by wt. of very finely divided mineral particles having anisotropic particle geometry.

The sum of the parts by weight of all the components are standardized to 100.

The composition can comprise compatibilizer (Component D) and/or vinyl (co)polymer (Component E) as further components.

### DETAILED DESCRIPTION OF THE INVENTION

The present invention is directed to a polymer composition composed of

(A) 55-90, preferably 60-85, more preferably 62-80 parts by wt. of a polyamide

(B) 0.5-50, preferably 1-30, more preferably 1-25 parts by wt. of a graft polymer

(C) 0.1-30, preferably 1-20, more preferably 2-15, in particular 4-13 parts by wt. of very finely divided mineral particles having anisotropic particle geometry.

The sum of the parts by weight of these components is 100.

Graft polymers based on ethylene/propylene rubbers (EPR) or rubbers based on ethylene/propylene and non-conjugated diene (EPDM) according to JP 11 24 1016 A2 are preferably excluded as the graft base of the graft polymers according to Component B of the present invention.

The invention furthermore also provides the moldings which have been subjected to on-line lacquering obtainable from the above mentioned compositions.

It has been found that a plastic with the above composition has an excellent heat distortion temperature and, on the basis of this, use in “on-line” lacquering processes is readily possible. It, furthermore, has a class A surface, high rigidity and outstanding resistance to chemicals.

One of the features of the present invention is that specific mineral particles are employed as Component C of the composition. As illustrated below in detail, these are distinguished by an anisotropic particle geometry. According to the present invention, particles having anisotropic particle geometry are understood as meaning those particles of which the so-called aspect ratio, i.e. the ratio of the largest and smallest particle dimension, is greater than 1, preferably greater than 2, and more preferably greater than about 5. Such particles are platelet-shaped or fibrous, at least in the broadest sense.

The components of the polymer composition, which are suitable according to the present invention, are explained below by way of example.

Polyamides (Component A) which are suitable according to the present invention are known or can be prepared by processes known from the literature.

Polyamides, which are suitable according to the invention, are known homopolyamides, copolyamides and mixtures of these polyamides. These can be partly crystalline and/or amorphous polyamides. Suitable partly crystalline polyamides are polyamide 6, polyamide 6,6 and mixtures thereof and corresponding copolymers of these components. Partly crystalline polyamides in which the acid component completely or partly comprises terephthalic acid and/or isophthalic acid and/or suberic acid and/or sebacic acid and/or azelaic acid and/or adipic acid and/or cyclohexanedicarboxylic acid, the diamine component completely or partly comprises m- and/or p-xylylenediamine and/or hexamethylenediamine and/or 2,2,4-trimethylhexamethylenediamine and/or 2,4,4-trimethylhexamethylenediamine and/or isophoronediamine and the composition of which is known in principle are also suitable.

Polyamides which are prepared completely or partly from lactams having 7 to 12 carbon atoms in the ring, optionally with the co-use of one or more of the above mentioned starting components, are also useful.

Preferably, Component A is a partly crystalline polyamide, such as polyamide 6 and polyamide 6,6 and mixtures thereof. Other known products can be employed as amorphous polyamides. They can be obtained by polycondensation of diamines, such as ethylenediamine, hexamethylenediamine, decamethylenediamine, 2,2,4- and/or 2,4,4-trimethylhexamethylenediamine, m- and/or p-xylylenediamine, bis-(4-aminocyclohexyl)-methane, bis-(4-aminocyclohexyl)-propane, 3,3′-dimethyl-4,4′-diamino-dicyclohexyl-methane, 3-aminomethyl-3,5,5-trimethylcyclohexylamine, 2,5- and/or 2,6-bis-(aminomethyl)-norbornane and/or 1,4-diaminomethylcyclohexane, with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Copolymers which are obtained by polycondensation of several monomers are also suitable, and furthermore copolymers which are prepared with the addition of aminocarboxylic acids, such as ε-amino-caproic acid, ω-aminoundecanoic acid or ω-aminolauric acid, or their lactams.

Preferred amorphous polyamides are the polyamides prepared from isophthalic acid, hexamethylenediamine and further diamines, such as 4,4-diaminodicyclohexylmethane, isophoronediamine, 2,2,4- and/or 2,4,4-trimethylhexamethylenediamine, 2,5- and/or 2,6-bis-(aminomethyl)-norbornene; or from isophthalic acid, 4,4′-diamino-dicyclohexylmethane and ε-caprolactam; or from isophthalic acid, 3,3′-dimethyl-4,4′-diamino-dicyclohexylmethane and lauryllactam; or from terephthalic acid and the isomer mixture of 2,2,4- and/or 2,4,4-trimethylhexamethylenediamine.

It is also possible to employ mixtures of the diaminodicyclo-hexylmethane position isomers, which contain 70 to 99 mol % of the 4,4′-diamino isomer, 1 to 30 mol % of the 2,4′-diamino isomer and 0 to 2 mol % of the 2,2′-diamino isomer, optionally diamines of correspondingly higher degree of condensation, which are obtained by hydrogenation of diaminodiphenylmethane of technical-grade quality. Up to 30% of the isophthalic acid can be replaced by terephthalic acid.

The polyamides preferably have a relative viscosity (measured on a 1 wt. % solution in m-cresol at 25° C.) of 2.0 to 5.0, particularly preferably of 2.5 to 4.0.

Component A can contain polyamides by themselves or in any mixture thereof.

Component B comprises one or more rubber-modified graft polymers. The rubber-modified graft polymer B contains a random (co)polymer of vinyl monomers, B.1, preferably according to, B.1.1 and B.1.2, and a rubber B.2 grafted with vinyl monomers, preferably according to B.1.1 and B.1.2. B.1, B.1.1, B.1.2 and B.2 are described in detail herein. The preparation of B is carried out in a known manner by free-radical polymerization, such as by an emulsion, bulk or solution or bulk-suspension polymerization process, as described in U.S. Pat. Nos. 3,243,481, 3,509,237, 3,660,535, 4,221,833 and 4,239,863. Suitable graft rubbers are also ABS polymers, which are obtainable by redox initiation with an initiator system of organic hydroperoxide and ascorbic acid in accordance with U.S. Pat. No. 4,937,285.

One or more graft polymers of 5 to 95, preferably 20 to 90 wt. % of at least one vinyl monomer B.1 on 95 to 5 wt. %, preferably 80 to 10 wt. % of one or more graft bases B.2 with glass transition temperatures of <10° C., preferably <−10° C., are preferred.

Preferred monomers B.1.1 include styrene, α-methylstyrene, styrenes substituted by halogen or alkyl on the nucleus, such as p-methylstyrene and p-chlorostyrene, and (meth)acrylic acid C₁-C₈-alkyl esters, such as methyl methacrylate, n-butyl acrylate and tert-butyl acrylate. Preferred monomers B.1.2 include unsaturated nitriles, such as acrylonitrile and methacrylonitrile, (meth)acrylic acid C₁-C₈-alkyl esters, such as methyl methacrylate, n-butyl acrylate and tert-butyl acrylate, and derivatives (such as anhydrides and imides) of unsaturated carboxylic acids, such as maleic anhydride and N-phenyl-maleimide, or mixtures thereof.

More preferred monomers B.1.1 are styrene, α-methylstyrene and/or methyl methacrylate, and more preferred monomers B.1.2 are acrylonitrile, maleic anhydride and/or methyl methacrylate.

Most preferred monomers of B.1.1 and B.1.2 are styrene and acrylonitrile, respectively.

Rubbers B.2 which are suitable for the rubber-modified graft polymers B are, for example, diene rubbers and acrylate, polyurethane, silicone, chloroprene and ethylene/vinyl acetate rubbers. Composites of various rubbers of those mentioned are also suitable as graft bases.

Preferred rubbers B.2 are diene rubbers, such as those based on butadiene, isoprene etc. or mixtures of diene rubbers or copolymers of diene rubbers or mixtures thereof with further copolymerizable vinyl monomers according to B.1.1 and B.1.2, with the glass transition temperature of Component B.2 below 10° C., and preferably below −10° C. Pure polybutadiene rubber is most preferred. The rubber base can comprise further copolymerizable monomers in an amount of up to 50 wt. %, preferably up to 30, in particular up to 20 wt. %, based on the rubber B.2.

Suitable acrylate rubbers according to B.2 of polymers B are, preferably, polymers of acrylic acid alkyl esters, optionally with up to 40 wt. %, based on B.2, of other polymerizable, ethylenically unsaturated monomers. The preferred polymerizable acrylic acid esters include C₁ to C₈-alkyl esters, for example the methyl, ethyl, butyl, n-octyl and 2-ethylhexyl ester; halogenoalkyl esters, preferably halogeno-C₁-C₈-alkyl esters, such as chloroethyl acrylate, and mixtures of these monomers. Other preferred polymerizable, ethylenically unsaturated monomers which can optionally be used, in addition to the acrylic acid esters, for the preparation of the graft base B.2 include acrylonitrile, styrene, α-methylstyrene, acrylamides, vinyl C₁-C₆-alkyl ethers, methyl methacrylate or butadiene. Preferred acrylate rubbers as the graft base B.2 are emulsion polymers, which have a gel content of at least 60 wt. %.

Further suitable graft bases according to B.2 are silicone rubbers with grafting-active sites, such as those described in DE-A 3 704 657, DE-A 3 704 655, DE-A 3 631 540 and DE-A 3 631 539.

The gel content of the graft base B.2 is determined at 25° C. in a suitable solvent as described in M. Hoffmann, H. Krömer, R. Kuhn, Polymeranalytik I and II, [Polymer Analysis I and II] Georg Thieme-Verlag, Stuttgart 1977.

The average particle size d₅₀ is the diameter above and below which in each case 50 wt. % of the particles lie. It can be determined by means of ultracentrifuge measurement as described in W. Scholtan, H. Lange, Kolloid-Z. and Z. Polymere 250 (1972), 782-1796.

Component B can additionally also contain, small amounts, usually less than 5 wt. %, preferably less than 2 wt. %, based on B.2, of ethylenically unsaturated monomers having a crosslinking action. Examples of such monomers having a crosslinking action include esters of unsaturated monocarboxylic acids having 3 to 8 C atoms and of unsaturated monohydric alcohols having 3 to 12 C atoms or of saturated polyols having 2 to 4 OH groups and 2 to 20 C atoms, polyunsaturated heterocyclic compounds and polyfunctional vinyl compounds, such as alkylene diol di(meth)-acrylates, polyester di(meth)-acrylates, divinylbenzene, trivinylbenzene, trivinyl cyanurate, triallyl cyanurate, allyl (meth)acrylate, diallyl maleate, diallyl fumarate, triallyl phosphate and diallyl phthalate.

Preferred crosslinking monomers are allyl methacrylate, ethylene glycol dimethacrylate, diallyl phthalate and heterocyclic compounds, which contain at least three ethylenically unsaturated groups.

In the case of preparation by means of bulk or solution or bulk-suspension polymerization, the rubber-modified graft polymer B is obtained by graft polymerization of 50 to 99, preferably 65 to 98, more preferably 75 to 97 parts by wt. of a mixture of 50 to 99, preferably 60 to 95 parts by wt. of monomers according to B.1.1 and 1 to 50, preferably 5 to 40 parts by wt. of monomers according to B.1.2 in the presence of 1 to 50, preferably 2 to 35, more preferably 2 to 15, in particular 2 to 13 parts by wt. of rubber Component B.2.

The average particle diameter d₅₀ of the grafted rubber particles in general has values of 0.05 to 10 μm, preferably 0.1 to 5 μm, most preferably 0.2 to 1 μm.

The average particle diameter d₅₀ of the resulting grafted rubber particles which are obtainable by means of the bulk or solution or bulk-suspension polymerization process, determined by counting on electron microscopy photographs, is in general in the range from 0.5 to 5 μm, preferably 0.8 to 2.5 μm.

Component B can contain the graft copolymers by themselves or in any desired mixture with one another.

The polymer composition according to the present invention preferably comprises Component B in an amount of 0.5 to 50 parts by wt., preferably 1 to 40 parts by wt., and more preferably 1 to 35 parts by wt.

Very finely divided mineral particles, Component C, which are suitable according to the invention, are those having anisotropic particle geometry. According to the present invention, mineral particles of anisotropic particle geometry are understood as meaning those particles of which the so-called aspect ratio, ratio of the largest and smallest particle dimension, is greater than 1, preferably greater than 2, and more preferably greater than about 5. Such particles are platelet-shaped or fibrous at least in the broadest sense. Such materials include, for example, particular talcs and particular (alumino)silicates, with a laminar or fibrous geometry, such as bentonite, wollastonite, mica substances (mica), kaolin, hydrotalcite, hectorite or montmorillonite.

Inorganic materials with a flaked or platelet-shaped character are preferably employed, such as talc, mica/clay layer materials, montmorillonite, the latter also in an organophilic form modified by ion exchange, kaolin and vermiculite.

Talc is particularly preferred. Talc is understood as meaning a naturally occurring or synthetically prepared talc. Pure talc has the chemical composition 3MgO.4SiO₂.H₂O and thus an MgO content of 31.9 wt. %, an SiO₂ content of 63.4 wt. % and a content of chemically bonded water of 4.8 wt. %. It is a silicate with a laminar structure.

Talc types of high purity are preferred. These comprise, for example, an MgO content of 28 to 35 wt. %, preferably 30 to 33 wt. %, more preferably 30.5 to 32 wt. %, and an SiO₂ content of 55 to 65 wt. %, preferably 58 to 64 wt. %, more preferably 60 to 62.5 wt. %. Preferred talc types are furthermore distinguished by an Al₂O₃ content of <5 wt. %, more preferably <1 wt. %, in particular <0.7 wt. %.

The use of talc in the form of finely ground types with an average particle size d₅₀ of <10 μm, preferably <5 μm, more preferably <2.5 μm, and more preferably ≦1.5 μm. The use of talc with an average particle size d₅₀ of 350 nm to 1.5 μm is most preferred.

Particle size and particle diameter in the context of the present invention means the average particle diameter d₅₀ determined by ultracentrifuge measurements in accordance with the method of W. Scholtan et al., Kolloid-Z. und Z. Polymere 250 (1972), p. 782-796.

The mineral particles can, furthermore, be surface-modified with organic molecules, for example silanized, in order to achieve a better compatibility with the polymers. Hydrophobic or hydrophilic surfaces can also be produced in this manner.

The inorganic materials described in U.S. Pat. No. 5,714,537 and 5,091,461 are very finely divided mineral particles of anisotropic particle geometry which are also suitable for use in the composition according to the present invention. These include talc, clay or a material of a similar type, which has a number-average particle size of ≦10 μm and a ratio of the average diameter to thickness (D/T) of 4 to 30. Several varieties of talc and clay filler materials have proved to be suitable.

As described in U.S. Pat. No. 5,091,461, longitudinal or plate-shaped materials with the small particles stated are particularly suitable, compared with fibrillous or spherical fillers. Those compositions which comprise particles which have a ratio of average diameter/thickness (D/T), measured in the manner described in U.S. Pat. No. 5,714,537, of at least 4, preferably at least 6, more preferably at least 7, are preferred. In respect of the maximum value for the ratio D/T, it has been found to be desirable to have a value of up to and including 30, preferably up to and including 24, more preferably up to and including 18, even more preferably up to and including 13, and most preferably up to and including 10.

Mineral particles, which are preferably to be used, are the known minerals of talc varieties and clay varieties. The non-calcined talc varieties and clays, which have a very low content of free metal oxide, are particularly preferred. Talc varieties and clay varieties are generally known fillers for various polymeric resins. These materials and their suitability as a filler for polymeric resins are described generally in U.S. Pat. Nos. 5,091,461 and 3,424,703 and EP-A 391 413.

The most suitable varieties of the mineral talc are hydrated magnesium silicates, such as are represented generally by the theoretical formula:

3MgO 4SiO₂H₂O.

The compositions of the talc varieties can vary somewhat with the location where they are mined. For example, talc varieties from Montana largely correspond to this theoretical composition. Suitable varieties of the mineral talc of this type are obtainable commercially as Microtalc MP 25-38 and Microtalc MP 10-52 from Pfizer.

The most suitable clay varieties are water-containing compounds of the aluminosilicate type, which are represented generally by the formula:

Al₂O₃ SiO₂ 2H₂O.

Suitable clay materials are commercially obtainable as clay of the variety Tex 10R from Anglo American Clay Co.

These mineral particles preferably have a number-average particle size, measured by a Coulter counter, of less than or equal to 10 micrometers (μm), more preferably less than or equal to 2 μm, even more preferably less than or equal to 1.5 μm, and most preferably less than or equal to 1.1 μm. Depending on the nature of the grinding or of the preparation, such fillers can have number-average particle sizes of at least 0.05 μm, preferably at least 0.1 μm, and more preferably at least 0.5 μm.

These mineral particles furthermore in general have a maximum particle size of less than or equal to 50 μm, preferably less than or equal to 30 μm, more preferably less than or equal to 25 mμ, even more preferably less than or equal to 20 μm, and most preferably less than or equal to 15 μm.

Another way of specifying the desired uniform small particle size and the particle size distribution of the mineral particles preferably used in the practical implementation of the present invention consists of stating that at least 98 wt. %, preferably at least 99 wt. %, of the particles of these in the finished mixture have an equivalent spherical volume diameter of less than 44 μm, preferably less than 20 μm. The percentage by weight of the filler particles with such diameters can similarly be measured by the particle size analysis with a Coulter counter.

The mineral particles can be in the form of powders, pastes, sols, dispersions or suspensions. Powders can be obtained by precipitation from dispersions, sols or suspensions.

The materials can be incorporated into the thermoplastic molding compositions by conventional processes, for example by direct kneading or extrusion of molding compositions and the very finely divided inorganic powders. Preferred processes are the preparation of a masterbatch, e.g. in flameproofing additives and at least one component of the molding compositions according to the present invention in monomers or solvents, or the coprecipitation of a thermoplastic component and the very finely divided inorganic powders, e.g., by coprecipitation of an aqueous emulsion and the very finely divided inorganic powders, optionally in the form of dispersions, suspensions, pastes or sols of the very finely divided inorganic materials.

Examples of substances which can preferably be employed according to the invention as mineral particles are Tremin® 939-300EST from Quarzwerke GmbH, Frechen, Germany (aminosilane-coated wollastonite with an average needle diameter of 3 μm), Finntalc® M30SL from Omya GmbH, Cologne, Germany (non-coated talc with a particle size d₅₀ =8.5 μm), Wicroll® 40PA from Omya GmbH, Cologne, Germany (silanized wollastonite with a particle size d₅₀=1.3 μm) and Burgess® 2211 from Omya GmbH, Cologne, Germany (aminosilane-coated aluminum silicate with a particle size d₅₀=1.3 μm), Naintsch A 3 (see examples Component C).

The composition according to the present invention can comprise the mineral particles of Component C in an amount of 0 to 30 parts by wt., preferably 0 to 20 parts by wt., and, more preferably 0.4 to 13 parts by wt.

Thermoplastic polymers with polar groups are preferably employed as compatibilizers.

Polymers which are employed according to the present invention contain:

D.1 a vinylaromatic monomer,

D.2 at least one monomer chosen from the group consisting of C₂ to C₁₂-alkyl methacrylates, C₂ to C₁₂-alkyl acrylates, methacrylonitriles and acrylonitriles and

D.3 α,β-unsaturated components comprising dicarboxylic acid anhydrides.

Styrene is preferred as vinylaromatic monomers D.1.

Acrylonitrile is preferred for Component D.2.

Maleic anhydride is preferred for α,β-unsaturated components comprising dicarboxylic acid anhydrides D.3.

Terpolymers of the monomers mentioned are preferably employed as Component D.1, D.2 and D.3. Terpolymers of styrene, acrylonitrile and maleic anhydride are accordingly preferably employed. These terpolymers contribute in particular towards improving the mechanical properties, such as tensile strength and elongation at break. The amount of maleic anhydride in the terpolymer can vary within wide limits. The amount is preferably 0.2 to 5 mol %. Amounts of between 0.5 and 1.5 mol % are more preferred. Particularly good mechanical properties in respect of tensile strength and elongation at break can be achieved in this range.

The terpolymer can be prepared in any known manner. A suitable method is dissolving of monomer components of the terpolymer, such as styrene, maleic anhydride or acrylonitrile, in a suitable solvent, such as methyl ethyl ketone (MEK). One or optionally more chemical initiators can be added to this solution. Suitable initiators include peroxides. The mixture is then polymerized at elevated temperatures for several hours. The solvent and the unreacted monomers are then removed in a known manner.

The ratio between Component D.1 (vinylaromatic monomer) and Component D.2, e.g., the acrylonitrile monomer, in the terpolymer is preferably between 80:20 and 50:50. To improve the miscibility of the terpolymer with the graft copolymer B, an amount of vinylaromatic monomer D.1 which corresponds to the amount of vinyl monomer B.1 in the graft copolymer B is preferably chosen.

Examples of compatibilizers D which can be employed according to the present invention are described in EP-A 785 234 and EP-A 202 214. The polymers mentioned in EP-A 785 234 are preferred.

Component D can contain the compatibilizer by itself or in any desired mixture with one another.

Another substance which is preferred as a compatibilizer is a terpolymer of styrene and acrylonitrile in a weight ratio of 2.1:1 containing 1 mol % of maleic anhydride.

The amount of Component D in the polymer composition according to the invention is preferably between 0.5 and 30 parts by wt., in particular between 1 and 20 parts by wt., and more preferably between 2 and 10 parts by wt. Amounts of between 3 and 7 parts by wt. are highly preferred.

Component E contains one or more thermoplastic vinyl (co)polymers.

Suitable vinyl (co)polymers for Component E are polymers of at least one monomer from the group containing vinylaromatics, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. (Co)polymers, which are particularly suitable, are those of:

E.1 50 to 99, preferably 60 to 80 parts by wt. of vinylaromatics and/or vinylaromatics substituted on the nucleus, such as styrene, α-methylstyrene, p-methylstyrene or p-chlorostyrene and/or methacrylic acid (C₁-C₈)-alkyl esters, such as methyl methacrylate or ethyl methacrylate and

E.2 1 to 50, preferably 20 to 40 parts by wt. of vinyl cyanides (unsaturated nitriles), such as acrylonitrile and methacrylonitrile, and/or (meth)acrylic acid (C₁-C₈)-alkyl esters, such as methyl methacrylate, n-butyl acrylate or tert-butyl acrylate and/or imides of unsaturated carboxylic acids, such as N-phenylmaleimide.

The (co)polymers E are resinous, thermoplastic and rubber-free. The copolymer of E.1 styrene and E.2 acrylonitrile is preferred.

The (co)polymers E are known and can be prepared by free-radical polymerization, in particular by emulsion, suspension, solution or bulk polymerization. The (co)polymers preferably have average molecular weights Mw (weight-average, determined by light scattering or sedimentation) of between 15,000 and 200,000.

Component E can contain the vinyl (co)polymers by themselves or in any desired mixture with one another.

The polymer composition contains Component E in an amount of 0 to 30 parts by wt., preferably 0 to 25 parts by wt., and more preferably 0 to 20 parts by wt., in particular 0.5 to 10 parts by wt.

The polymer compositions according to the invention can contain conventional additives (Component F), such as flameproofing agents, anti-dripping agents, very finely divided inorganic compounds which differ from Component D, lubricants and mold release agents, nucleating agents, antistatics, stabilizers, fillers and reinforcing substances and dyestuffs and pigments.

The compositions according to the invention can in general comprise 0.01 to 20 wt. %, based on the total composition, of flameproofing agents. Flameproofing agents which are mentioned by way of example include organic halogen compounds, such as decabromobisphenyl ether and tetrabromobisphenol, inorganic halogen compounds, such as ammonium bromide, nitrogen compounds, such as melamine and melamine-formaldehyde resins, inorganic hydroxide compounds, such as Mg-Al hydroxide, inorganic compounds, such as aluminum oxides, titanium dioxides, antimony oxides, barium metaborate, hydroxoantimonate, zirconium oxide, zirconium hydroxide, molybdenum oxide, ammonium molybdate, tin borate, ammonium borate and tin oxide, and siloxane compounds.

Phosphorus compounds such as are described in EP-A 363 608, EP-A 345 522 and/or EP-A 640 655 can also be employed as flameproofing compounds.

Possible further filling and reinforcing materials are those which differ from Component E. Suitable materials are, for example, glass fibers, optionally cut or ground, glass beads, glass balls, kaolins, talc substances, mica substances, silicates, quartz, talc, titanium dioxide, wollastonite, mica, carbon fibers or mixtures thereof. Cut or ground glass fibers are preferably employed as the reinforcing material. Preferred fillers, which can also have a reinforcing action, include glass balls, mica substances, silicates, quartz, talc, titanium dioxide and wollastonite.

The compositions according to the present invention are prepared by mixing the particular constituents in a known manner and subjecting the mixture to melt compounding and melt extrusion at temperatures of 200° C. to 300° C. in conventional units, such as internal kneaders, extruders and twin-screw extruders, the mold releasing agent being employed in the form of a coagulated mixture.

The mixing of the individual constituents can be carried out in a known manner both successively and simultaneously, and in particular both at about 20° C. (room temperature) and at a higher temperature.

The polymer compositions according to the present invention can be used for the production of all types of moldings. In particular, moldings can be produced by injection molding. Examples of moldings include all types of housing components, for example for domestic appliances, such as electric shavers, flat screens, monitors, printers, copiers or cover sheets for the building sector and components for motor and rail vehicles. They can furthermore be employed in the field of electrical engineering because they have very good electrical properties.

The polymer compositions according to the present invention can furthermore be used, for example, for the production of the following moldings:

Interior finishing components for rail vehicles, ships, buses, other motor vehicles and aircraft, hub caps, housings of electrical appliances containing small transformers, housings for equipment for information transmission and transfer, flat wall elements, housings for safety equipment, rear spoilers and other vehicle body components for motor vehicles, thermally insulated transportation containers, devices for housing or care of small animals, cover grids for ventilator openings, moldings for garden houses and tool sheds, housings for garden equipment.

The present invention includes moldings prepared by thermoforming from previously produced sheets or films.

The present invention therefore also provides the use of the compositions according to the invention for the production of any type of moldings.

On the basis of the excellent on-line lacquerability, the present invention also provides moldings which have been subjected to on-line lacquering, preferably motor vehicle external components, for example wheel guards, mud guards, mirror outer housings etc.

The following examples serve to further illustrate the invention.

### EXAMPLES

In accordance with the data in Table 1, the compositions are produced, further processed to test specimens and tested.

| | |
|---|---|
| Component A: | Polyamide 6,6 (Radipol ® A45, Chimica SPA, Cologno |
| | Mouzese). |
| Component | Noryl ® GTX 974, General Electric Plastics, Bergen op |
| A2: | Zoomen, The Netherlands. |
| Component B: | Graft polymer of 40 parts by wt. of a copolymer of |
| | styrene and acrylonitrile in a ratio of 73:27 on 60 parts |
| | by wt. of polybutadiene rubber crosslinked in |
| | particulate form (average particle diameter d₅₀ = |
| | 0.28 μm), prepared by emulsion polymerization. |
| Component C: | Naintsch A3 (Naintsch Mineralwerke GmbH, Graz, |
| | Austria) Talc with an average particle diameter (d₅₀) |
| | according to the manufacturer of 1.2 μm. |
| Component D: | Terpolymer of styrene and acrylonitrile with a weight |
| | ratio of 2.1:1 comprising 1 mol % of maleic anhydride. |
| Component E: | Styrene/acrylonitrile copolymer with a |
| | styrene/acrylonitrile weight ratio of 72:28 and a limiting |
| | viscosity of 0.55 dl/g (measurement in dimethyl- |
| | formamide at 20° C.). |
| Component F: | Additives, see table 1. |

Preparation and Testing of the Molding Compositions According to the Invention.

Mixing of the components of the compositions was carried out on a 3 l internal kneader. The shaped articles were produced on an injection molding machine of the type Arburg 270 E at 260° C.

The heat distortion temperature HDT was determined in accordance with ISOR 75.

The longitudinal expansion coefficient (pm×K⁻¹) was determined in accordance with ASTM E 831.

To determine the optical shrinkage measurement, a 60×60×2 mm sheet was injection-molded at a material temperature of 260° C., a pressure of 500 bar and a mold temperature of 80° C. This sheet was then measured immediately in the longitudinal and transverse direction, subsequently heat-treated for 1 h at 80° C. and then measured again. The difference in the length measurements was stated in % as the length or width shrinkage. This procedure was repeated five times and the mean is stated. The results of the individual tests are summarized in Table 1.

TABLE 1

| Examples | | C1 | 1 | 2 |
|---|---|---|---|---|
| Components | | | | |
| A1 | Polyamide 6,6 | | 65.91 | 62.62 |
| A2 | Noryl ® GTX 974 | 100 | | |
| B | Graft polymer | | 20.00 | 19.05 |
| C | Talc | | 9.42 | 8.95 |
| D | Compatibilizer | | | 4.92 |
| E | Styrene/acrylonitrile | | 3.01 | 2.86 |
| | copolymer | | | |
| F1 | Mold release agent | | 0.25 | 0.25 |
| F2 | Stabilizers | | 1.41 | 1.35 |
| Properties | | | | |
| aₙ (RT) | [kJ/m²] | n.b.¹⁾ | 66.3 b²⁾ | n.b.¹⁾ |
| E-modulus | [Gpa] | 2,150 | 3,000 | 3,200 |
| HDTB | [° C.] | 180 | 186 | 194 |
| Shrinkage | [%] | 1.3 | — | 0.95 |
| Therm. | 10⁻⁴/K | 0.76 | 0.76 | 0.75 |
| Expansion | | | | |
| coefficient | | | | |
| Surface | | OK³⁾ | | OK |

¹⁾n.b. = not broken
²⁾b = brittle breaking properties
³⁾OK = in order (class A)

In an on-line lacquering, material of example (2) passed through the complete lacquering line. Subsequent testing resulted in a better toughness than in the case of C1, an equally good surface and better shrinkage properties.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Composition comprising
A) 55 to 90 parts by wt. of a polyamide,
B) 0.5 to 50 parts by wt. of a graft polymer and
C) 0.1 to 30 parts by wt. of a mineral particle having anisotropic particle geometry,
wherein the graft polymer is not based on ethylene-propylene rubbers or rubbers based on ethylene-propylene and non-conjugated dienes as a graft base, and
wherein the sum of the parts by weight of all the components being standardized to 100.

2. Composition according to claim 1, further comprising a compatibilizer as Component D.

3. Composition according to claim 2, comprising 0.5 to 50 parts by wt. of component D.

4. Composition according to claim 1, further comprising a vinyl (co)polymer.

5. Composition according to claim 4, comprising up to 30 parts by wt. of vinyl (co)polymer.

6. Composition according to claim 1, wherein the mineral particle has an aspect ratio of greater than 1.

7. Composition according to claim 6, wherein the mineral particle has an aspect ratio of greater than 2.

8. Composition according to claim 7, wherein the mineral particle has an aspect ratio of greater than 5.

9. Composition according to claim 1, wherein the mineral particle is platelet-shaped or fibrous.

10. Composition according to claim 1, wherein the mineral particle is a talc, a silicate or an alumosilicate with a laminar or fibrous geometry.

11. Composition according to claim 10, wherein the mineral particle is bentonite, wollastonite, mica, kaolin, hydrotalcite, hectorite or montmorillonite.

12. Composition according to claim 10, wherein the talc has a magnesium oxide content of 28 to 35 wt. % and a silicon dioxide content of 55 to 65 wt. %.

13. Composition according to claim 10, wherein the talc has an average particle size d₅₀ of <10 μm.

14. Composition according to claim 1, wherein the graft polymer has at least one vinyl monomer on at least one graft base and a glass transition temperature of <10° C.

15. Composition according to claim 1, wherein the graft polymer of at least one monomer is
B.1.1) styrene, α-methylstyrene, styrenes substituted by halogen or alkyl on the nucleus and (meth)acrylic acid C₁-C₈-alkyl esters, and
B.1.2) unsaturated nitriles, (meth)acrylic acid C-C₈-alkyl esters and derivatives of unsaturated carboxylic acids on a graft base with a glass transition temperature of <10° C.

16. Composition according to claim 1, wherein the graft base is chosen is from at last one rubber from the group consisting of a diene rubber, a copolymer of a diene rubber, an acrylate rubber, a polyurethane rubber, a silicone rubber, a chloroprene rubber and an ethylene/vinyl acetate rubber.

17. Composition according to claim 16, wherein the graft base is a diene rubber, a copolymer of a diene and a vinyl monomer or mixtures thereof.

18. Composition according to claim 1, further comprising a vinyl (co)polymer, a flameproofing agent, an anti-dripping agent, a filler, a reinforcing substance which differs from Component C, or an additive.

19. A molding produced by a composition comprising.
A) 55 to 90 parts by wt. of a polyamide,
B) 0.5 to 50 parts by wt. of a graft polymer and
C) 0.1 to 30 parts by wt. of a mineral particle having anisotropic particle geometry,
wherein the graft polymer is not based on ethylene-propylene rubbers or rubbers based on ethylene-propylene and non-conjugated dienes as a graft base, and
wherein the sum of the parts by weight of all the components being standardized to 100.

20. A motor vehicle external component comprising
A) 55 to 90 parts by wt. of a polyamide,
B) 0.5 to 50 parts by wt. of a graft polymer and
C) 0.1 to 30 parts by wt. of a mineral particle having anisotropic particle geometry,
wherein the graft polymer is not based on ethylene-propylene rubbers or rubbers based on ethylene-propylene and non-conjugated dienes as a graft base,
wherein the sum of the parts by weight of all the components being standardized to 100, and
wherein the motor vehicle external component has been on-line lacquered.

21. A molding comprising
A) 55 to 90 parts by wt. of a polyamide,
B) 0.5 to 50 parts by wt. of a graft polymer and
C) 0.1 to 30 parts by wt. of a mineral particle having anisotropic particle geometry,
wherein the graft polymers are not based on ethylene-propylene rubbers or rubbers based on ethylene-propylene and non-conjugated dienes as a graft base,
wherein the sum of the parts by weight of all the components being standardized to 100, and
wherein the molding has been on-line lacquered.
